(19) United States
(12) Patent Application Publication
(10) Pub. No.: US 2026/0059106 A1
(43) Pub. Date: Feb. 26, 2026

(54) METHODS AND APPARATUS ON CHROMA MOTION COMPENSATION USING ADAPTIVE CROSS-COMPONENT FILTERING

(71) Applicant: BEIJING DAJIA INTERNET INFORMATION TECHNOLOGY CO., LTD., Beijing (CN)

(72) Inventors: Changyue MA, San Diego, CA (US); Xiaoyu XIU, San Diego, CA (US); Wei CHEN, San Diego, CA (US); Hong-Jheng JHU, San Diego, CA (US); Che-Wei KUO, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/376,335

(22) Filed: Oct. 31, 2025

Related U.S. Application Data
(63) Continuation of application No. PCT/US2024/029311, filed on May 14, 2024.
(60) Provisional application No. 63/466,637, filed on May 15, 2023.

(51) Int. Cl. H04N 19/117; H04N 19/139; H04N 19/176; H04N 19/196; H04N 19/513; H04N 19/577

(52) U.S. Cl. CPC H04N 19/117; H04N 19/139; H04N 19/176; H04N 19/196; H04N 19/521; H04N 19/577

(57) ABSTRACT

Methods for video decoding and encoding, apparatuses and non-transitory computer-readable storage media thereof are provided. In one method for video decoding, a decoder may obtain a plurality of reconstructed luma samples for a current inter coding block, obtain an adaptive cross-component filter, and obtain a filtered motion compensated chroma sample based on the adaptive cross-component filter and the plurality of reconstructed luma samples.

### CROSS-REFERENCE TO RELATED APPLICATION

The present application is based upon and claims priority to International Application No. PCT/US2024/029311, filed on May 14, 2024, which is based upon and claims priority to U.S. Provisional Application No. 63/466,637, entitled “Methods and apparatus on chroma motion compensation using adaptive cross-component filtering,” filed on May 15, 2023. The entireties of forgoing applications are incorporated herein by reference for all purposes.

### FIELD

The present disclosure is related to video coding and compression, and in particular but not limited to, methods and apparatus on improving the coding efficiency of the inter blocks which applies cross-component filtering to generate the prediction samples of the chroma components for the blocks.

### BACKGROUND

Various video coding techniques may be used to compress video data. Video coding is performed according to one or more video coding standards. For example, video coding standards include versatile video coding (VVC), high-efficiency video coding (H.265/HEVC), advanced video coding (H.264/AVC), moving picture expert group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

The first version of the VVC standard was finalized in July 2020, which offers approximately 50% bit-rate saving or equivalent perceptual quality compared to the prior generation video coding standard HEVC. Although the VVC standard provides significant coding improvements than its predecessor, there is evidence that superior coding efficiency can be achieved with additional coding tools. Recently, Joint Video Exploration Team (JVET) under the collaboration of ITU-T VECG and ISO/IEC MPEG started the exploration of advanced technologies that can enable substantial enhancement of coding efficiency over VVC. In April 2021, one software codebase, called Enhanced Compression Model (ECM) was established for future video coding exploration work. The ECM reference software was based on VVC Test Model (VTM) that was developed by JVET for the VVC, with several existing modules (e.g., intra/inter prediction, transform, in-loop filter and so forth) are further extended and/or improved. In future, any new coding tool beyond the VVC standard need to be integrated into the ECM platform, and tested using JVET common test conditions (CTCs).

### SUMMARY

The present disclosure provides examples of techniques relating to improving the coding efficiency of the inter blocks.

According to a first aspect of the present disclosure, there is provided a method for video decoding of an inter coding block. In the method, a decoder may obtain a plurality of reconstructed luma samples for a current inter coding block, obtain an adaptive cross-component filter, and obtain a filtered motion compensated chroma sample based on the adaptive cross-component filter and the plurality of reconstructed luma samples.

According to a second aspect of the present disclosure, there is provided a method for video encoding of an inter coding block. In the method, an encoder may obtain a plurality of reconstructed luma samples for a current inter coding block, obtain an adaptive cross-component filter, and obtain a filtered motion compensated chroma sample based on the adaptive cross-component filter and the plurality of reconstructed luma samples.

According to a third aspect of the present disclosure, there is provided an apparatus for video decoding. The apparatus may include one or more processors and a memory coupled to the one or more processors and configured to store instructions executable by the one or more processors. Furthermore, the one or more processors, upon execution of the instructions, are configured to perform the method according to the first aspect.

According to a fourth aspect of the present disclosure, there is provided an apparatus for video encoding. The apparatus may include one or more processors and a memory coupled to the one or more processors and configured to store instructions executable by the one or more processors. Furthermore, the one or more processors, upon execution of the instructions, are configured to perform the method according to the second aspect.

According to a fifth aspect of the present disclosure, there is provided a non-transitory computer-readable storage medium for storing computer-executable instructions that, when executed by one or more computer processors, cause the one or more computer processors to receive a bitstream, and perform the method according to the first aspect based on the bitstream.

According to a sixth aspect of the present disclosure, there is provided a non-transitory computer-readable storage medium for storing computer-executable instructions that, when executed by one or more computer processors, cause the one or more computer processors to perform the method according to the second aspect to encode the current block into a bitstream, and transmit the bitstream.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1A is a block diagram illustrating a system for encoding and decoding video blocks in accordance with some examples of the present disclosure.

FIG. 1B is a block diagram of an encoder in accordance with some examples of the present disclosure.

FIGS. 1C-1F are block diagrams illustrating how a frame is recursively partitioned into multiple video blocks of different sizes and shapes in accordance with some examples of the present disclosure.

FIG. 1G is a block diagram illustrating an exemplary video encoder in accordance with some examples of the present disclosure

FIG. 2A is a block diagram of a decoder in accordance with some examples of the present disclosure.

FIG. 2B is a block diagram illustrating an exemplary video decoder in accordance with some examples of the present disclosure.

FIG. 3A is a diagram illustrating block partitions in a multi-type tree structure in accordance with some examples of the present disclosure.

FIG. 3B is a diagram illustrating block partitions in a multi-type tree structure in accordance with some examples of the present disclosure.

FIG. 3C is a diagram illustrating block partitions in a multi-type tree structure in accordance with some examples of the present disclosure.

FIG. 3D is a diagram illustrating block partitions in a multi-type tree structure in accordance with some examples of the present disclosure.

FIG. 3E is a diagram illustrating block partitions in a multi-type tree structure in accordance with some examples of the present disclosure.

FIG. 4 shows one example where dₓ and d_{y} are the horizontal and vertical values of the MV in accordance with some examples of the present disclosure.

FIG. 5 shows an example where one MV has one fractional value and interpolation filters are applied to generate the corresponding prediction samples at fractional sample positions in accordance with some examples of the present disclosure.

FIG. 6A and FIG. 6B show examples of two diamond filter shapes in accordance with some examples of the present disclosure.

FIG. 7 shows a subsampled 1-D Laplacian calculation applied for gradient calculations in all the directions in accordance with some examples of the present disclosure.

FIG. 8 shows a filtering operation in the CC-ALF accomplished by applying a diamond shaped filter to the luma channel in accordance with some examples of the present disclosure.

FIG. 9 is a block diagram showing a video encoder when the CC-MCP according to the present disclosure is applied.

FIG. 10 is a block diagram of the decoder of the present disclosure that receives the bit-stream produced by the encoder in FIG. 9.

FIG. 11 is a diagram Illustrating decoder-side CC-MCP filter coefficient derivation in accordance with some examples of the present disclosure.

FIG. 12 is a block diagram of the CC-MCP which uses the high-frequency information of reconstructed luma samples as guidance to improve the quality of motion compensated chroma samples in accordance with some examples of the present disclosure.

FIG. 13 is a diagram illustrating a computing environment coupled with a user interface in accordance with some examples of the present disclosure.

FIG. 14 is a flow chart illustrating a method for video decoding in accordance with some examples of the present disclosure.

FIG. 15 is a flow chart illustrating a method for video encoding corresponding to the method for video decoding as shown in FIG. 14 in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may include steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

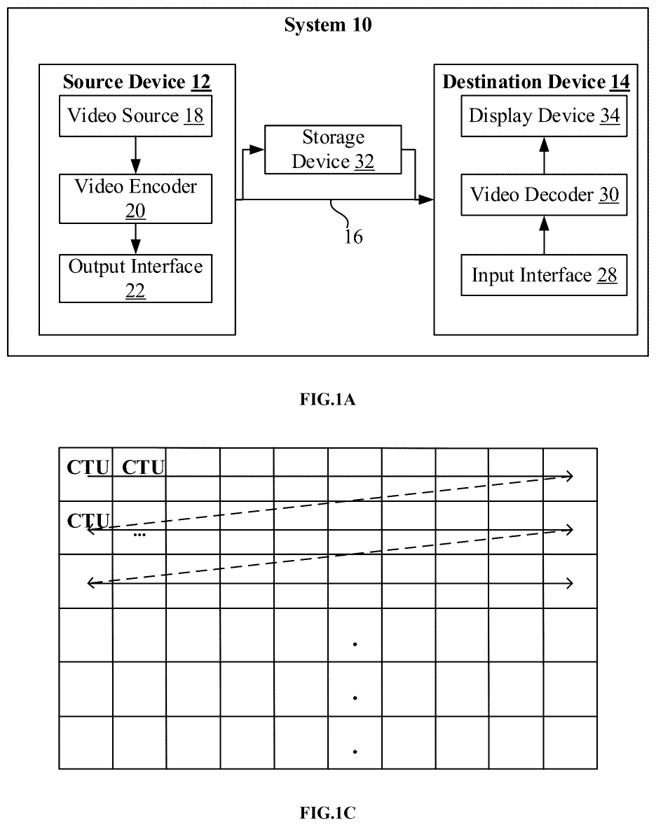

FIG. 1A is a block diagram illustrating an exemplary system 10 for encoding and decoding video blocks in parallel in accordance with some implementations of the present disclosure. As shown in FIG. 1A, the system 10 includes a source device 12 that generates and encodes video data to be decoded at a later time by a destination device 14. The source device 12 and the destination device 14 may include any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1A, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

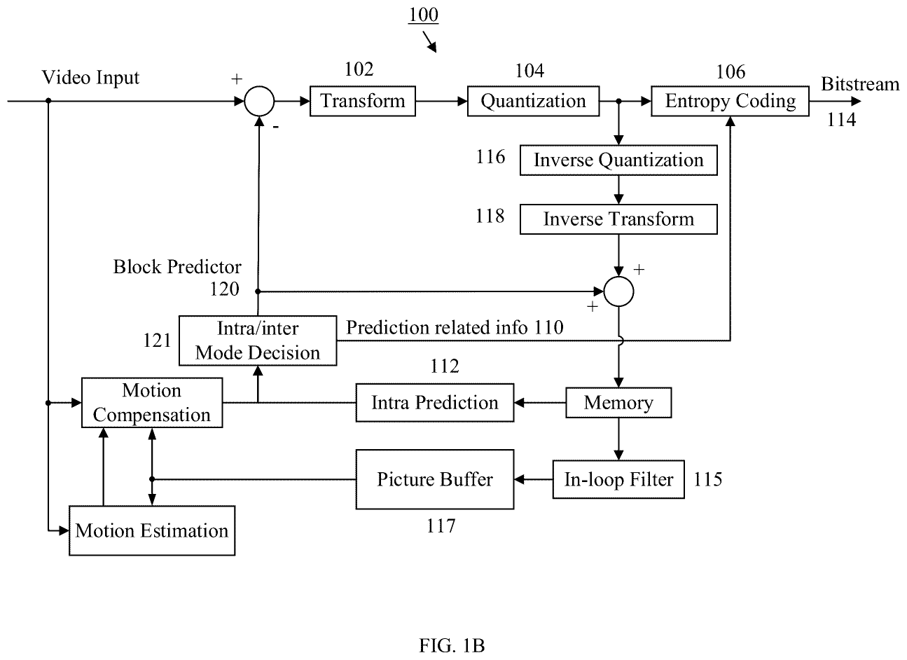

In some implementations, at least a part of components of the source device 12 (for example, the video source 18, the video encoder 20 or components included in the video encoder 20 as described below with reference to FIG. 1G, and the output interface 22) and/or at least a part of components of the destination device 14 (for example, the input interface 28, the video decoder 30 or components included in the video decoder 30 as described below with reference to FIG. 2B, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

Like HEVC, VVC is built upon the block-based hybrid video coding framework. FIG. 1B is a block diagram illustrating a block-based video encoder in accordance with some implementations of the present disclosure. In the encoder 100, the input video signal is processed block by block, called coding units (CUs). The encoder 100 may be the video encoder 20 as shown in FIG. 1A. In VTM-1.0, a CU can be up to 128×128 pixels. However, different from the HEVC which partitions blocks only based on quad-trees, in VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure.

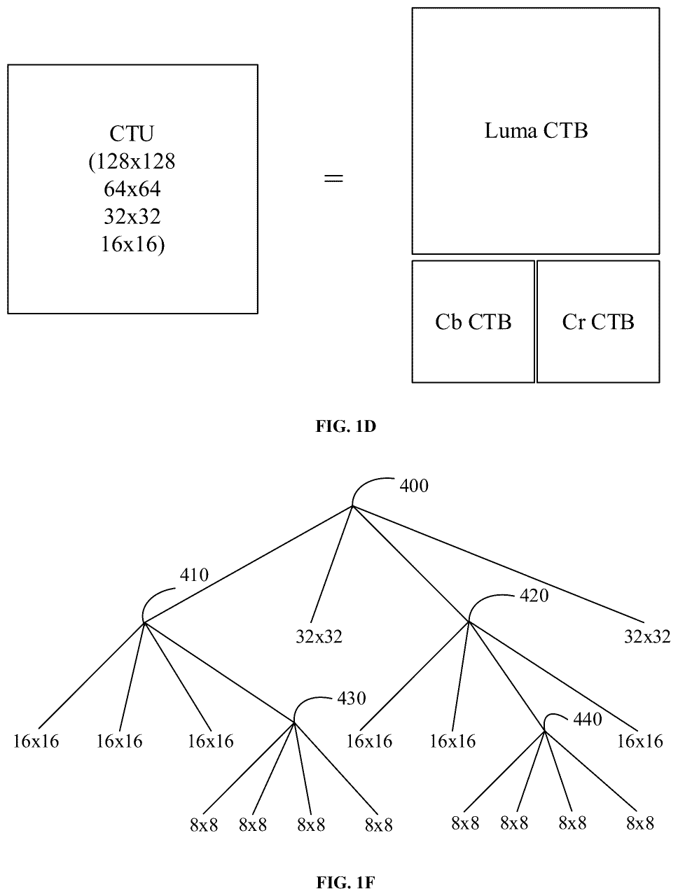

FIGS. 3A-3E are schematic diagrams illustrating multi-type tree splitting modes in accordance with some implementations of the present disclosure. FIGS. 3A-3E respectively show five splitting types including quaternary partitioning (FIG. 3A), vertical binary partitioning (FIG. 3B), horizontal binary partitioning (FIG. 3C), vertical ternary partitioning (FIG. 3D), and horizontal ternary partitioning (FIG. 3E).

For each given video block, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes.

After spatial and/or temporal prediction, an intra/inter mode decision circuitry 121 in the encoder 100 chooses the best prediction mode, for example based on the rate-distortion optimization method. The block predictor 120 is then subtracted from the current video block; and the resulting prediction residual is de-correlated using the transform circuitry 102 and the quantization circuitry 104. The resulting quantized residual coefficients are inverse quantized by the inverse quantization circuitry 116 and inverse transformed by the inverse transform circuitry 118 to form the reconstructed residual, which is then added back to the prediction block to form the reconstructed signal of the CU. Further, in-loop filtering 115, such as a deblocking filter, a sample adaptive offset (SAO), and/or an adaptive in-loop filter (ALF) may be applied on the reconstructed CU before it is put in the reference picture store of the picture buffer 117 and used to code future video blocks. To form the output video bitstream 114, coding mode (inter or intra), prediction mode information, motion information, and quantized residual coefficients are all sent to the entropy coding unit 106 to be further compressed and packed to form the bit-stream.

For example, a deblocking filter is available in AVC, HEVC as well as the now-current version of VVC. In HEVC, an additional in-loop filter called SAO is defined to further improve coding efficiency. In the now-current version of the VVC standard, yet another in-loop filter called ALF is being actively investigated, and it has a good chance of being included in the final standard.

These in-loop filter operations are optional. Performing these operations helps to improve coding efficiency and visual quality. They may also be turned off as a decision rendered by the encoder 100 to save computational complexity.

It should be noted that intra prediction is usually based on unfiltered reconstructed pixels, while inter prediction is based on filtered reconstructed pixels if these filter options are turned on by the encoder 100.

FIG. 2A is a block diagram illustrating a block-based video decoder 200 which may be used in conjunction with many video coding standards. This decoder 200 is similar to the reconstruction-related section residing in the encoder 100 of FIG. 1B. The block-based video decoder 200 may be the video decoder 30 as shown in FIG. 1A. In the decoder 200, an incoming video bitstream 201 is first decoded through an Entropy Decoding 202 to derive quantized coefficient levels and prediction-related information. The quantized coefficient levels are then processed through an Inverse Quantization 204 and an Inverse Transform 206 to obtain a reconstructed prediction residual. A block predictor mechanism, implemented in an Intra/inter Mode Selector 212, is configured to perform either an Intra Prediction 208, or a Motion Compensation 210, based on decoded prediction information. A set of unfiltered reconstructed pixels are obtained by summing up the reconstructed prediction residual from the Inverse Transform 206 and a predictive output generated by the block predictor mechanism, using a summer 214.

The reconstructed block may further go through an In-Loop Filter 209 before it is stored in a Picture Buffer 213 which functions as a reference picture store. The reconstructed video in the Picture Buffer 213 may be sent to drive a display device, as well as used to predict future video blocks. In situations where the In-Loop Filter 209 is turned on, a filtering operation is performed on these reconstructed pixels to derive a final reconstructed Video Output 222.

FIG. 1G is a block diagram illustrating another exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 1G, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1A. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 1G, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1A, or archived in the storage device 32 as shown in FIG. 1A for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 2B is a block diagram illustrating another exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 1G. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 2B. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1A.

In the current VVC and AVS3 standards, motion information of the current coding block is either copied from spatial or temporal neighboring blocks specified by a merge candidate index or obtained by explicit signaling of motion estimation. The focus of the present disclosure is to improve the accuracy of the motion vectors for affine merge mode by improving the derivation methods of affine merge candidates. To facilitate the description of the present disclosure, the existing affine merge mode design in the VVC standard is used as an example to illustrate the proposed ideas. Please note that though the existing affine mode design in the VVC standard is used as the example throughout the present disclosure, to a person skilled in the art of modern video coding technologies, the proposed technologies can also be applied to a different design of affine motion prediction mode or other coding tools with the same or similar design spirit.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

As shown in FIG. 1C, the video encoder 20 (or more specifically a partition unit in a prediction processing unit of the video encoder 20) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 1D, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 1E, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 1F depicts a quad-tree data structure illustrating the end result of the partition process of the CTU 400 as depicted in FIG. 1E, each leaf node of the quad-tree corresponding to one CU of a respective size ranging from 32×32 to 8×8. Like the CTU depicted in FIG. 1D, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 1E-IF is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIGS. 3A-3E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 1E, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit as described above in connection with FIG. 1B, the motion vector predictor of the current CU is subtracted from the actual motion vector of the current CU to produce a Motion Vector Difference (MVD) for the current CU. By doing so, there is no need to encode the motion vector determined by the motion estimation unit for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

The present disclosure is to further enhance the chroma coding efficiency of the motion compensation module that is applied in the ECM. In the following, some related coding tools that are applied in the transform and entropy coding process in the ECM are briefly reviewed. After that, some deficiencies in the existing design of motion compensation are discussed. Finally, the solutions are provided to improve the existing design.

### Motion Compensated Prediction (MCP)

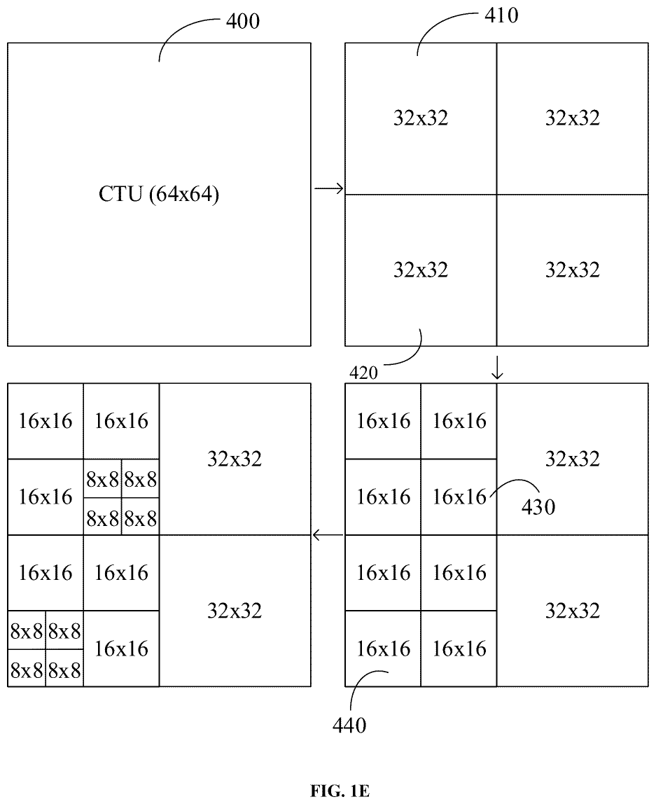

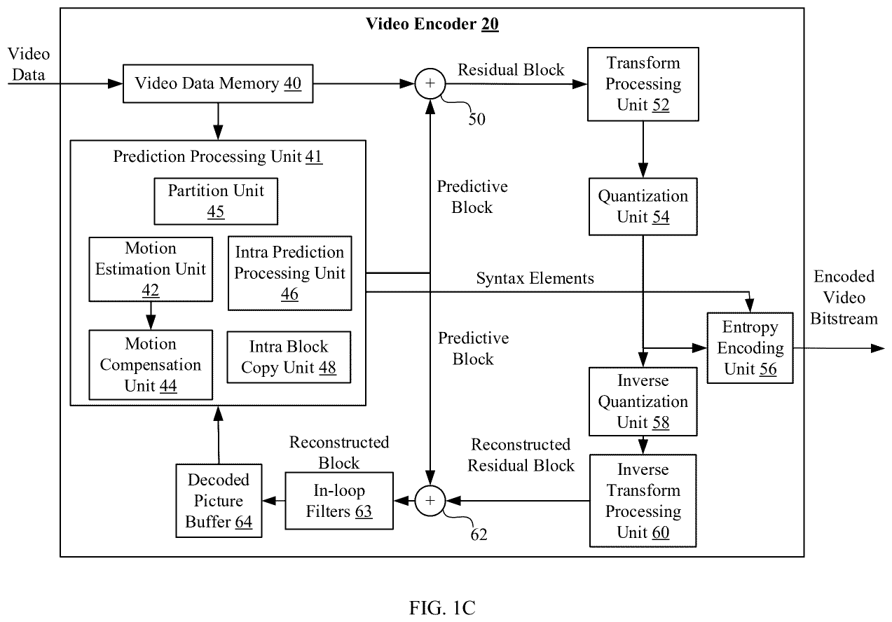

Motion compensated prediction (MCP), which is also known as motion compensation in short, is one of the most widely used video coding techniques in the development of the modern video coding standards. In the MCP, one video frame is partitioned into multiple blocks (which are called prediction unit (PU)). Each PU is predicted from a block in the equal size from one temporal reference picture such that the overhead that is needed to signal the block is significantly reduced. In all the existing video coding standards, each inter PU is associated with a set of motion parameters which consist of one or two MVs and reference picture indices. The inter PUs in a P slice only have one reference picture list while the PUs in a B slice may use up to two reference picture lists. In the MCP, the corresponding inter prediction samples are generated from its corresponding region in the reference picture as identified by the MV and the reference picture index. The MV specifies the horizontal and vertical displacement between the current block and its reference block in the reference picture. FIG. 4 shows one example where dₓ and d_{y} are the horizontal and vertical values of the MV. In practice, the value of one MV may be in fractional precisions. When one MV has one fractional value, interpolation filters are applied to generate the corresponding prediction samples at fractional sample positions, as illustrated in FIG. 5. In the VVC, it supports MVs with the unit of 1/16 of the distance between two neighboring luma samples for the luma MC and 1/32 of the distance of two neighboring chroma samples for the chroma MC.

### Adaptive Loop Filtering

In the VVC and ECM, adaptive loop filtering (ALF) where one among 25 filters is selected for each 4×4 block based on the direction and activity of local gradients.

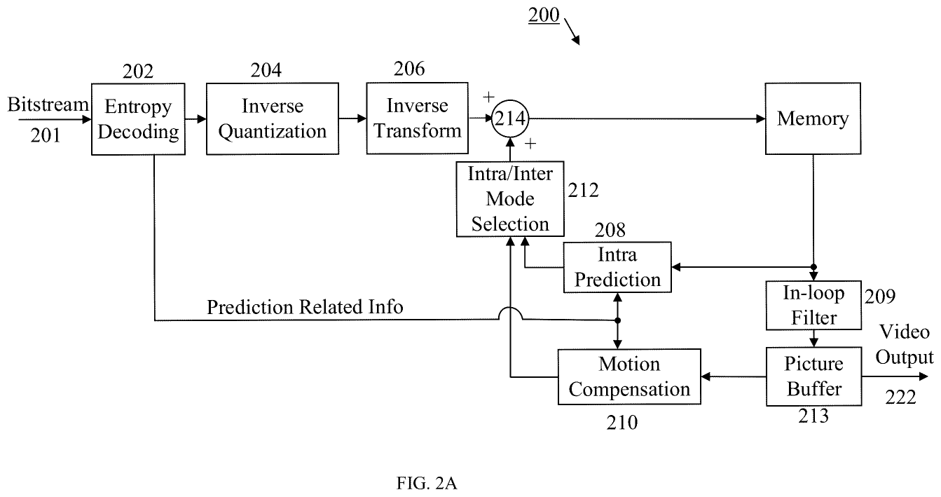

Filter shape: Two diamond filter shapes (as shown in FIG. 6A-6B) are used. The 7×7 diamond shape is applied for luma component and the 5×5 diamond shape is applied for chroma components.

Block classification: For luma component, each 4×4 block is categorized into one out of 25 classes. The classification index C is derived based on its directionality D and a quantized value of activity Â, as follows:

$$C = 5 D + \hat{A} \qquad ( 1 )$$

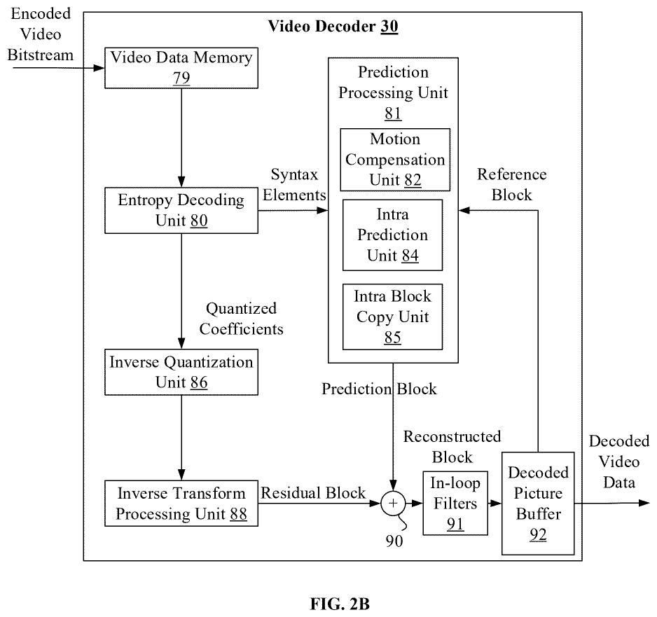

To calculate D and Â, gradients of the horizontal, vertical and two diagonal directions are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

where indices i and j refer to the coordinates of the upper left sample within the 4×4 block and R(i, j) indicates a reconstructed sample at coordinate (i, j). To reduce the complexity of block classification, shown in FIG. 7, the subsampled 1-D Laplacian calculation is applied for the gradient calculations in all the directions.
Then, D maximum and minimum values of the gradients of horizontal and vertical directions are set as:

$${g}_{h , v}^{max} = max ( {g}_{h} , {g}_{v} ) g\_ {( h , v )}^{⋀} min = min ( g\_h , g\_v ) \qquad ( 3 )$$

The maximum and minimum values of the gradient of two diagonal directions are set as:

$${g}_{d 0 , d 1}^{max} = max ( {g}_{d 0} , {g}_{d 1} ) g\_ ( d 0 , d 1 ) {}^{⋀} min = min ( g\_d0 , g\_d1 ) \qquad ( 4 )$$

To derive the value of the directionality D, these values are compared against each other and with two thresholds t₁ and t₂:
Step 1. If both

$${g}_{h , v}^{max} \leq {t}_{1} \cdot {g}_{h , v}^{min} \_ {( d 0 , d 1 )}^{⋀} max \leq {t}_{-} 1 \cdot g\_ {( d 0 , d 1 )}^{⋀} min$$

are true, D is set to 0.
Step 2. If

$${g}_{h , v}^{max} / {g}_{h , v}^{min} > {g}_{d 0 , d 1}^{max} / {g}_{d 0 , d 1}^{min}$$

inue from Step 3; otherwise continue from Step 4.
Step 3. If

$${g}_{h , v}^{max} > {t}_{2} \cdot {g}_{h , v}^{min} s$$

set to 2; otherwise D is set to 1.
Step 4. If

$${g}_{d 0 , d 1}^{max} > {t}_{2} \cdot {g}_{d 0 , d 1}^{min} s$$

set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) \qquad ( 5 )$$

A is further quantized to the range of 0 to 4, inclusively, and the quantized value is denoted as Â. For chroma components in a picture, no classification method is applied.

### Geometric Transformations of Filter Coefficients and Clipping Values

Before filtering each 4×4 luma block, geometric transformations such as rotation or diagonal and vertical flipping are applied to the filter coefficients f(k, l) and to the corresponding filter clipping values c(k, l) depending on gradient values calculated for the block. This is equivalent to applying these transformations to the samples in the filter support region. The idea is to make different blocks to which ALF is applied more similar by aligning their directionality.

Three geometric transformations, including diagonal, vertical flip and rotation are provided:

$$Diagonal : {f}_{D} ( k , l ) = f ( l , k ) , {c}_{D} ( k , l ) = c ( l , k ) , \qquad ( 6 )$$

$$Vertical flip : {f}_{V} ( k , l ) = f ( k , K - l - 1 ) , {c}_{V} ( k , l ) = c ( k , K - l - 1 )$$

$$Rotation : {f}_{R} ( k , l ) = f ( K - l - 1 , k ) , {c}_{R} ( k , l ) = c ( K - l - 1 , k )$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k, l) and to the clipping values c(k, l) depending on gradient values calculated for that block. The relationship between the transformation and the four gradients of the four directions are summarized in the following

TABLE 1
Table 1

| Gradient values | Transformation |
|---|---|
| gd2 < gd1 and gh < gv | No transformation |
| gd2 < gd1 and gv < gh | Diagonal |
| gd1 < gd2 and gh < gv | Vertical flip |
| gd1 < gd2 and gv < gh | Rotation |

### Filter Process

When ALF is enabled for a CTB, each sample R(i, j) within the CU is filtered, resulting in sample value R′(i, j) as shown below,

$${R}^{′} ( i , j ) = R ( i , j ) + ( ( {\sum }_{k \neq 0} {\sum }_{l \neq 0} f ( k , l ) \times Clip 3 ( R ( i + k , j + l ) - R ( i , j ) , c ( k , l ) ) + 64 ) >> 7 ) \qquad ( 7 )$$

where f(k, l) denotes the decoded filter coefficients, K(x, y) is the clipping function and c(k, l) denotes the decoded clipping parameters. The variable k and I are between

$$- \frac{L}{2} and \frac{L}{2}$$

where L denotes the filter length. Clip3 (−y, y, x) is the clipping function which clips the input value of x to the range [−y, y]. The clipping operation introduces non-linearity to make ALF more efficient by reducing the impact of neighbor sample values that are too different with the current sample value.

### Cross-Component Adaptive Loop Filter

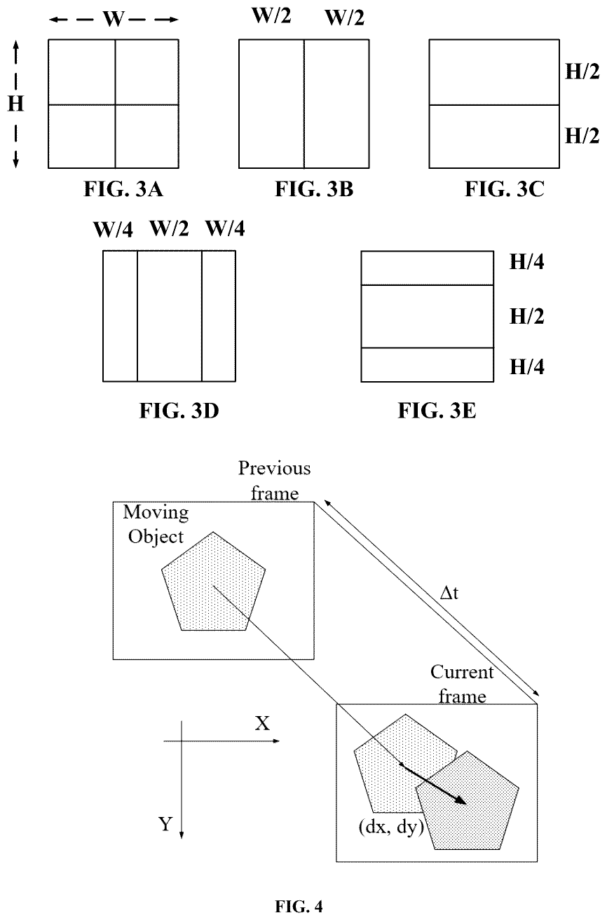

Cross-component adaptive loop filter (CC-ALF) uses luma samples to refine each of two chroma components by applying an adaptive linear filter to the luma channel and then using the output of this filtering operation for chroma refinement. As shown in FIG. 8, the filtering operation in the CC-ALF is accomplished by applying a diamond shaped filter to the luma channel. One filter is used for each chroma channel, and the operation is expressed as

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} ) \qquad ( 8 )$$

where (x, y) is chroma location being refined and (x_{Y}, y_{Y}) is the collocated luma location based on (x, y), Sᵢ is filter support area in luma component, cᵢ(x₀, y₀) represents the filter coefficients.

A maximum of 8 CC-ALF filters can be designed and transmitted per picture. The resulting filters are then indicated for each of the two chroma channels on a CTU basis. Additionally, the following characteristics are also included in the existing CC-ALF design:
The design uses a 3×4 diamond shape with 8 taps.
Seven filter coefficients are transmitted in the APS.
Each of the transmitted coefficients has a 6-bit dynamic range and is restricted to power-of-2 values.
The eighth filter coefficient is derived at the decoder such that the sum of the filter coefficients is equal to 0.
An APS may be referenced in the slice header.
CC-ALF filter selection is controlled at CTU-level for each chroma component.

The MCP plays a key role to ensure the efficiency of inter coding in all the existing video coding standards. With the MCP, the video signal to be coded is predicted from temporally neighboring signal and only the prediction error, the MVs and the reference picture indices are transmitted. Meanwhile, both the ALF and the CC-ALF can effectively increase the quality of reconstructed video, thus improving the performance of inter coding by providing high-quality reference pictures. However, the quality of temporal reference pictures may not be good enough to provide efficient inter prediction, especially for the chroma components, due to the following reasons:

Video signal may be coded with coarse quantization, i.e., high quantization parameter (QP) values. When coarse quantization is applied, the reconstructed picture may contain severe coding artifacts such as blocking artifacts, ringing artifacts, etc. This may cause certain high-frequency information that are present in the original picture to be missing and/or distorted in the reconstructed picture, e.g., in the form of distorted edges and blurred textures. Given that the reconstructed signal of the current picture will be used as reference for temporal prediction, such missing and/or distorted high-frequency information could reduce the effective of MCP and therefore inter coding efficiency for subsequent pictures.

Since human vision system is much more sensitive to variations in brightness than color, a video coding system usually devotes more bits to the luma component than chroma components, e.g., by adjusting the QP delta value between luma component and chroma components. Additionally, chroma components usually have smaller dynamic range, therefore are smoother than luma component. Consequently, more transform coefficients of chroma components become zero after quantization. Therefore, the problem of missing or distorted high-frequency information can be much more pronounced in the reconstructed chroma signal. This could seriously affect the prediction efficiency of chroma components as more bits need to be generated to code chroma residue signal. Although CC-ALF may be capable of restoring the missed high-frequency information in the reconstructed pictures, which however could be attenuated at the motion compensation stage when they are used as the reference pictures for inter prediction.

In the present disclosure, methods are proposed to improve the efficiency of motion compensate prediction for the chroma components and therefore enhance the quality of temporal prediction. Specifically, it is proposed to apply adaptive cross-component filtering at the motion compensation stage, which is called cross-component motion compensated prediction (CC-MCP), which uses the high-frequency information of motion compensated luma samples as guidance to improve the quality of motion compensated chroma samples. By such way, the energy of chroma residuals is minimized, thus reducing the overhead of signaling chroma signals.

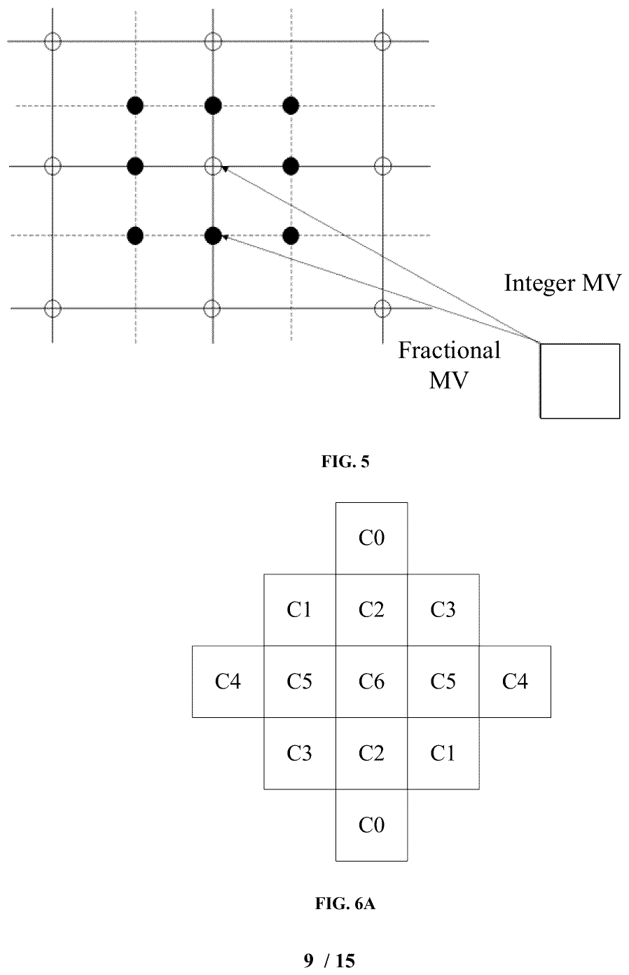

FIG. 9 provides the block diagram of the video encoder when the proposed CC-MCP is applied. Firstly, similar to the conventional video encoder, the motion estimation and compensation module generates the motion compensated luma and chroma signals by matching the current block to one block in reference picture using the optimal MV. Then, an adaptive cross-component filter, i.e., the CC-MCP filtering, is provided where the motion compensated chroma signal is filtered with the proposed CC-MCP filter according to the corresponding motion compensated luma signal to generate the filtered motion compensated chroma signal. After that, the original signal is subtracted from the prediction signal to remove temporal redundancy and produce the corresponding residual signal. The transform and quantization are applied to the residual signal which are then entropy-coded and output to bit-stream. To obtain the reconstructed signal, the reconstructed residual signal is made available by inverse quantization and inverse transform. Then, the reconstructed residual is added to the motion compensated prediction. Further, in-loop filtering processes, e.g., de-blocking, ALF and SAO, are applied to the reconstructed video signal for output. As will be discussed later, the filter coefficients of the proposed CC-MCP filter may be directly derived from the neighboring reconstructed luma and chroma samples at decoder or derived at encoder and be sent to decoder. Additionally, in order to maximize the coding gain of the proposed method, additional syntax may be signaled at a given block level (e.g., CTU, CU, or PU level) to indicate whether the proposed CC-MCP filtering is applied to the current block for motion compensation or not.

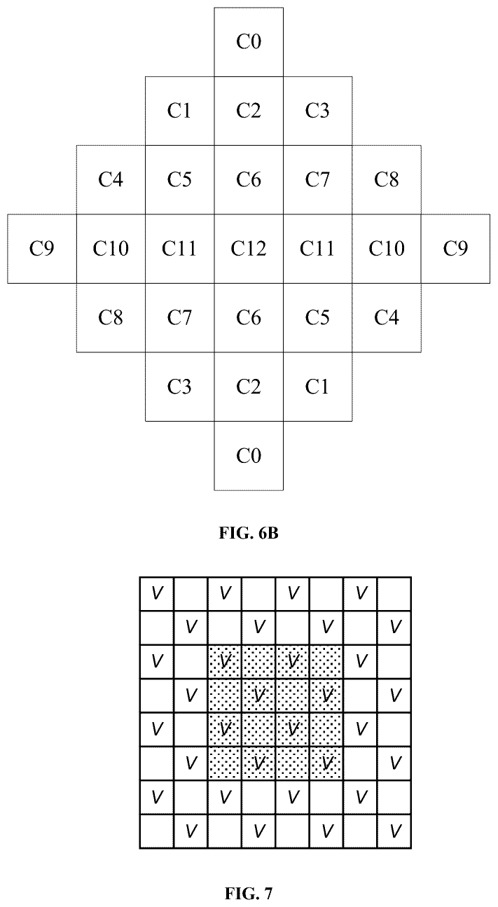

FIG. 10 shows a block diagram of the proposed decoder that receives the bit-stream produced by the encoder in FIG. 9. At the decoder, the bit-stream is first parsed by the entropy decoder. The residual coefficients are then inverse quantized and inverse transformed to obtain the reconstructed residual. For temporal prediction, prediction signal is firstly generated by obtaining the motion compensated block using the signaled prediction information (i.e., MV and reference index). Then, if it is parsed from the bitstream that the CC-MCP is enabled for the block, the motion compensated chroma signal is further processed by the proposed CC-MCP filtering; otherwise, the motion compensated chroma signal is not filtered. Then, the motion compensated signal (either filtered or un-filtered) and the reconstructed residual are added together to get the reconstructed video. The reconstructed video may additionally go through loop filtering before being stored in the reference picture store to be displayed and/or to be used to decode future video signal.

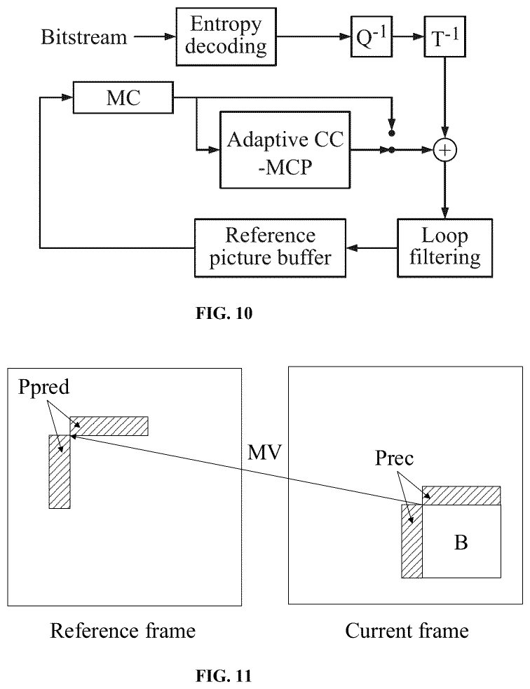

In the second method, the proposed CC-MCP uses the high-frequency information of reconstructed luma samples as guidance to improve the quality of motion compensated chroma samples, where the block diagram is presented in FIG. 12. At the encoder, firstly, similar to the conventional video encoder, the motion estimation and compensation module generates the motion compensated luma and chroma signals by matching the current block to one block in reference picture using the optimal MV. After that, the original luma signal is subtracted from the prediction luma signal to remove temporal luma redundancy and produce the corresponding residual luma signal. The transform and quantization are applied to the residual luma signal which are then entropy-coded and output to bit-stream.

To obtain the reconstructed luma signal, the reconstructed residual luma signal is made available by inverse quantization and inverse transform. Then, the reconstructed residual luma is added to the motion compensated luma prediction. Then, the CC-MCP filtering is introduced where the motion compensated chroma signal is filtered with the proposed CC-MCP filter according to the corresponding reconstructed luma signal to generate the filtered motion compensated chroma signal. After that, the original chroma signal is subtracted from the prediction chroma signal to remove temporal chroma redundancy and produce the corresponding residual chroma signal. The transform and quantization are applied to the residual chroma signal which are then entropy-coded and output to bit-stream.

To obtain the reconstructed chroma signal, the reconstructed residual chroma signal is made available by inverse quantization and inverse transform. Then, the reconstructed chroma residual is added to the motion compensated chroma prediction.

Further, in-loop filtering processes, e.g., de-blocking, ALF and SAO, are applied to the reconstructed video signal (contains both reconstructed luma signal and reconstructed chroma signal) for output. As will be discussed later, the filter coefficients of the proposed CC-MCP filter may be directly derived from the neighboring reconstructed luma and chroma samples at decoder or derived at encoder and be sent to decoder. Additionally, in order to maximize the coding gain of the proposed method, additional syntax may be signaled at a given block level (e.g., CTU, CU, or PU level) to indicate whether the proposed CC-MCP filtering is applied to the current block for motion compensation or not.

At the decoder, the bit-stream is first parsed by the entropy decoder. The residual coefficients are then inverse quantized and inverse transformed to obtain the reconstructed residual. For temporal prediction, prediction signal is firstly generated by obtaining the motion compensated block using the signaled prediction information (i.e., MV and reference index).

After that, the motion compensated luma signal and the reconstructed residual luma are added together to get the reconstructed luma signal.

Then, if it is parsed from the bitstream that the CC-MCP is enabled for the block, the motion compensated chroma signal is further processed by the proposed CC-MCP filtering; otherwise, the motion compensated chroma signal is not filtered.

Then, the motion compensated chroma signal (either filtered or un-filtered) and the reconstructed residual chroma are added together to get the reconstructed chroma signal.

Finally, the reconstructed video (contains both reconstructed luma signal and reconstructed chroma signal) may additionally go through loop filtering before being stored in the reference picture store to be displayed and/or to be used to decode future video signal.

### The CC-MCP Filtering Process of Motion Compensated Chroma Signal

Since human vision system is much more sensitive to variations in brightness than color, a video coding system usually devotes more bits to the luma component than chroma components, e.g., by adjusting the QP delta value between luma component and chroma components. Therefore, chroma components are often smoother than luma component. As a result, more transform coefficients are quantized to zero and there will be more blurred edges and textures in the reconstructed chroma signal. This could reduce the prediction efficiency for chroma and consequently more overhead needs to be spent on coding chroma residuals. Although ALF may be applied to reduce the distortion between the reference chroma signal and the original chroma signal, it cannot recover the high-frequency information that are missing in reconstructed chroma signal, due to the low-pass characteristics of ALF filters.

In the disclosure, the blurred edges and textures in chroma channel of the temporal prediction signal may be restored or repaired by using the corresponding neighboring samples in the luma channel. Specifically, it is provided to apply a cross-component filtering during the motion compensation stage which uses the high-frequency information of motion compensated luma signal as guidance to improve the quality of motion compensated chroma signal. Specifically, it is assumed C(x, y) and C′(x, y) indicate the original reconstructed chroma sample and the filtered reconstructed chroma samples at the coordinate (x, y); f_{c}(x, y) indicates the coefficients of the high-pass filter that is applied to the corresponding H×L neighboring region of reconstructed luma samples Y(2x−i, 2y−j), where

$$- \frac{H - 1}{2} \leq x \leq \frac{H - 1}{2} , - \frac{L - 1}{2} \leq y \leq \frac{L - 1}{2} .$$

The proposed CC-MCP filtering can be calculated based on following equation.

$${C}^{′} ( x , y ) = Y ( 2 x , 2 y ) * {f}_{c} ( x , y ) + C ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times Y ( 2 x - i , 2 y - j ) + C ( x , y ) \qquad ( 9 )$$

In another embodiment, besides the linear filter coefficients (i.e., f_{c}(i, j)'s in (9)), it is proposed to introduce additional offset term and non-linear terms into the proposed CC-MCP filter design. Specifically, based on the same notations in (9), the chroma prediction samples generated from the CC-MCP process can be formulated as

$${C}^{′ ( x , y )} = Y ( 2 x , 2 y ) * {f}_{c} ( x , y ) + {o}_{c} + {nl}_{c} + C ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times Y ( 2 x - i , 2 y - j ) + {o}_{c} + {\sum }_{k = 2}^{K - 1} {nl}_{c}^{k} \times {Y ( 2 x , 2 y )}^{k} + C ( x , y ) \qquad ( 10 )$$

where o_{c} is the offset and nl_{c} is the non-linear term which is represented as the summation of a series of powers (i.e., k=2, . . . , K−1) of the collocated luma sample Y(2x, 2y).

In the second method, it is proposed to apply a cross-component filtering during the motion compensation stage which uses the high-frequency information of reconstructed luma signal as guidance to improve the quality of motion compensated chroma signal. Specifically, it is assumed Cₚ(x, y) and

$${C}_{P}^{′} ( x , y )$$

indicate the original motion compensated chroma sample and the filtered motion compensated chroma samples at the coordinate (x, y); f_{c}(x, y) indicates the coefficients of the high-pass filter that is applied to the corresponding H×L neighboring region of reconstructed luma samples (sum of motion compensated luma samples and reconstructed residual luma samples) Y_{R}(2x−i, 2y−j), where

$$- \frac{H - 1}{2} \leq x \leq \frac{H - 1}{2} , - \frac{L - 1}{2} \leq y \leq \frac{L - 1}{2} .$$

The proposed CC-MCP filtering can be calculated as

$${C}_{P}^{′} ( x , y ) = {Y}_{R} ( 2 x , 2 y ) * {f}_{c} ( x , y ) + {C}_{P} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times {Y}_{R} ( 2 x - i , 2 y - j ) + {C}_{P} ( x , y ) \qquad ( 11 )$$

In another embodiment, besides the linear filter coefficients (i.e., f_{c}(i, j)'s in (11)), it is proposed to introduce additional offset term and non-linear terms into the proposed CC-MCP filter design. Specifically, based on the same notations in (11), the chroma prediction samples generated from the CC-MCP process can be formulated as

$${C}_{P}^{′} ( x , y ) = {Y}_{R} ( 2 x , 2 y ) * {f}_{c} ( x , y ) + {o}_{c} + {nl}_{c} + {C}_{P} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times {Y}_{R} ( 2 x - i , 2 y - j ) + {o}_{c} + {\sum }_{k = 2}^{K - 1} {nl}_{c}^{k} \times {{Y}_{R} ( 2 x , 2 y )}^{k} + {C}_{P} ( x , y ) \qquad ( 12 )$$

where o_{c} is the offset and nl_{c} is the non-linear term which is represented as the summation of a series of powers (i.e., k=2, . . . , K−1) of the collocated reconstructed luma sample Y_{R}(2x, 2y).

In the third method, it is proposed to apply a cross-component filtering during the motion compensation stage which uses the reconstructed luma signal as guidance to improve the quality of motion compensated chroma signal. Specifically, it is assumed Cₚ(x, y) and

$${C}_{P}^{′} ( x , y )$$

indicate the original motion compensated chroma sample and the filtered motion compensated chroma samples at the coordinate (x, y); f_{c}(x, y) indicates the coefficients of the filter that is applied to the corresponding H×L neighboring region of reconstructed luma samples (sum of motion compensated luma samples and reconstructed residual luma samples) Y_{R}(2x−i, 2y−j), where

$$- \frac{H - 1}{2} \leq x \leq \frac{H - 1}{2} , - \frac{L - 1}{2} \leq y \leq \frac{L - 1}{2} .$$

The proposed CC-MCP filtering can be calculated as

$${C}_{P}^{′} ( x , y ) = {Y}_{R} ( 2 x , 2 y ) * {f}_{c} ( x , y ) = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times {Y}_{R} ( 2 x - i , 2 y - j ) \qquad ( 13 )$$

In another embodiment, besides the linear filter coefficients (i.e., f_{c}(i, j)'s in (13)), it is proposed to introduce additional offset term and non-linear terms into the proposed CC-MCP filter design. Specifically, based on the same notations in (13), the chroma prediction samples generated from the CC-MCP process can be formulated as

$${C}_{P}^{′} ( x , y ) = {Y}_{R} ( 2 x , 2 y ) * {f}_{c} ( x , y ) + {o}_{c} + {nl}_{c} = {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times {Y}_{R} ( 2 x - i , 2 y - j ) + {o}_{c} + {\sum }_{k = 2}^{K - 1} {nl}_{c}^{k} \times {{Y}_{R} ( 2 x , 2 y )}^{k} \qquad ( 14 )$$

where o_{c} is the offset and nl_{c} is the non-linear term which is represented as the summation of a series of powers (i.e., k=2, . . . , K−1) of the collocated reconstructed luma sample Y_{R}(2x, 2y).

### Decoder-Side Derivation of the CC-MCP Filter Coefficients

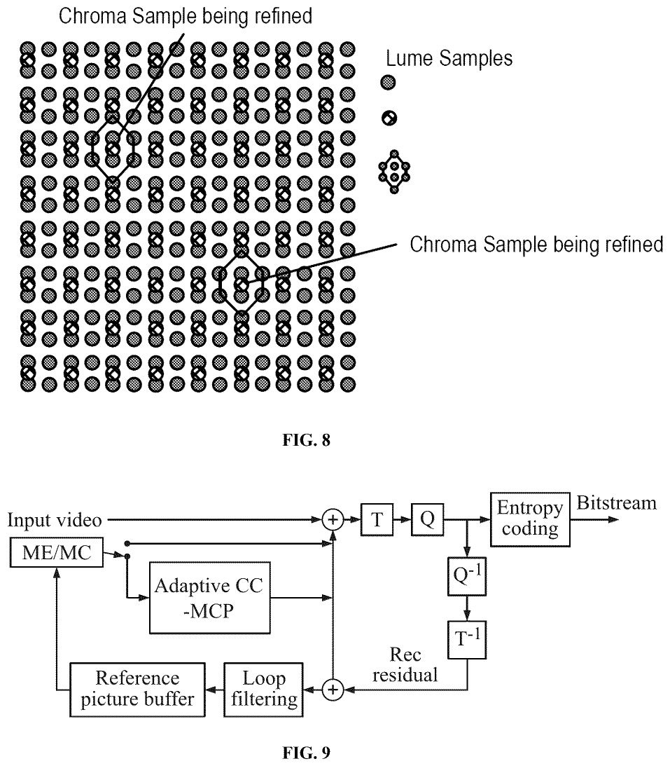

In the following, three decoder-side methods aligning with the three methods presented in the section “The CC-MCP filtering process of motion compensated chroma signal” are proposed where the coefficients of the proposed CC-MCP filter are derived at decoder without signaling. For the first method presented in the section “The CC-MCP filtering process of motion compensated chroma signal”, specifically, when the CC-MCP filtering is applied to one block, the method derives the coefficients from the neighboring reconstructed chroma samples of the current block and its corresponding luma and chroma prediction samples. FIG. 11 illustrates the proposed decoder-side filter coefficient derivation method. Specifically, given one block B and its pre-defined neighboring region P (e.g., the reconstructed chroma samples in

$${P}_{c}^{rec} ) ,$$

we can find the corresponding luma prediction samples

$${P}_{Y}^{pred}$$

and chroma prediction samples

$${P}_{c}^{pred}$$

using the coded MV of the current block. Then the LMMSE method can be employed to derive the filter coefficients by taking

$${P}_{Y}^{pred} and {P}_{c}^{pred}$$

as the input to the CC-MCP filter and minimize the difference between

$${P}_{c}^{rec}$$

and the resulting output from the CC-MCP filtering, i.e.,

$${f}_{c}^{*} = arg min {\sum }_{x} {\sum }_{y} {\vert {P}_{c}^{out} ( x , y ) - {P}_{c}^{rec} ( x , y ) \vert}^{2} = \\ arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times \\ {P}_{Y}^{pred} ( 2 x - i , 2 y - j ) ) + {P}_{c}^{pred} ( x , y ) - {P}_{c}^{rec} ( x , y ) ]}^{2} \qquad ( 15 )$$

After that, the derived filters can be applied to enhance the chroma prediction signal of the current block, as shown in equation (9).

When considering both the offset term and the non-linear term in (10), the LMMSE based CC-MCP filter coefficient derivation can be formulated as

$${f}_{c}^{*} = arg min {\sum }_{x} {\sum }_{y} {\vert {P}_{c}^{out} ( x , y ) - {P}_{c}^{rec} ( x , y ) \vert}^{2} = \\ arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times \\ {P}_{Y}^{pred} ( 2 x - i , 2 y - j ) ) + \\ {o}_{c} + {\sum }_{k = 2}^{K - 1} {nl}_{c}^{k} \times {Y ( 2 x , 2 y )}^{k} + {P}_{c}^{pred} ( x , y ) - {P}_{c}^{rec} ( x , y ) ]}^{2} \qquad ( 16 )$$

On the other side, as the proposed method takes the motion compensated samples of neighboring region at the target for the LMMSE derivation, it may be more beneficial to apply the proposed decoder-side derivation method when the reconstructed signal of the current picture contains higher quality reconstructed information than that of the reference picture. Therefore, in one embodiment of the disclosure, the proposed decoder-side derivation method is only applied when the reference picture uses smaller QP value than the current picture.

For the second method presented in the section “The CC-MCP filtering process of motion compensated chroma signal”, when the CC-MCP filtering is applied to one block, the method derives the coefficients from the neighboring reconstructed chroma samples of the current block and its corresponding reconstructed luma samples and chroma prediction samples. Specifically, given one block B and its pre-defined neighboring region

$$( e . g . , the reconstructed chro ma samples in {P}_{c}^{rec} ) ,$$

we can find the corresponding reconstructed luma samples

$${P}_{Y}^{rec}$$

and chroma prediction samples

$${P}_{c}^{pred}$$

using the coded MV of the neighboring block. In some other embodiments, chroma prediction samples

$${P}_{c}^{pred}$$

may be obtained by using the coded MV of the current block. Then the LMMSE method can be employed to derive the filter coefficients by taking

$${P}_{Y}^{rec} and {P}_{c}^{pred}$$

as the input to the CC-MCP filter and minimize the difference between

$${P}_{c}^{rec}$$

and the resulting output from the CC-MCP filtering, i.e.,

$${f}_{c}^{*} = arg min {\sum }_{x} {\sum }_{y} {\vert {P}_{c}^{out} ( x , y ) - {P}_{c}^{rec} ( x , y ) \vert}^{2} = \\ arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times \\ {P}_{Y}^{rec} ( 2 x - i , 2 y - j ) ) + {P}_{c}^{pred} ( x , y ) - {P}_{c}^{rec} ( x , y ) ]}^{2} \qquad ( 17 )$$

After that, the derived filters can be applied to enhance the chroma prediction signal of the current block, as shown in (11).

When considering both the offset term and the non-linear term in (12), the LMMSE based CC-MCP filter coefficient derivation can be formulated as

$${f}_{c}^{*} = arg min {\sum }_{x} {\sum }_{y} {\vert {P}_{c}^{out} ( x , y ) - {P}_{c}^{rec} ( x , y ) \vert}^{2} = \\ arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times \\ {P}_{Y}^{rec} ( 2 x - i , 2 y - j ) ) + \\ {o}_{c} + {\sum }_{k = 2}^{K - 1} {nl}_{c}^{k} \times {{P}_{Y}^{rec} ( 2 x , 2 y )}^{k} + {P}_{c}^{pred} ( x , y ) - {P}_{c}^{rec} ( x , y ) ]}^{2} \qquad ( 18 )$$

In one embodiment of the disclosure, the proposed decoder-side derivation method is only applied when the reference picture uses smaller QP value than the current picture.

For the third method presented in the section “The CC-MCP filtering process of motion compensated chroma signal”, when the CC-MCP filtering is applied to one block, the method derives the coefficients from the neighboring reconstructed chroma samples of the current block and its corresponding reconstructed luma samples. Specifically, given one block B and its pre-defined neighboring region P

$$( e . g . , the reconstructed chro ma samples in {P}_{c}^{rec} ) ,$$

we can find the corresponding reconstructed luma samples

$${P}_{Y}^{rec} .$$

Then the LMMSE method can be employed to derive the filter coefficients by taking

$${P}_{Y}^{rec}$$

as the input to the CC-MCP movement inter and minimize the difference between

$${P}_{c}^{rec}$$

and the resuming output from the CC-MCP filtering, i.e.,

$${f}_{c}^{*} = arg min {\sum }_{x} {\sum }_{y} {\vert {P}_{c}^{out} ( x , y ) - {P}_{c}^{rec} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times {P}_{Y}^{rec} ( 2 x - i , 2 y - j ) ) - {P}_{c}^{rec} ( x , y ) ]}^{2} \qquad ( 19 )$$

After that, the derived filters can be applied to enhance the chroma prediction signal of the current block, as shown in (13).

When considering both the offset term and the non-linear term in (14), the LMMSE based CC-MCP filter coefficient derivation can be formulated as

$${f}_{c}^{*} = arg min {\sum }_{x} {\sum }_{y} {\vert {P}_{c}^{out} ( x , y ) - {P}_{c}^{rec} ( x , y ) \vert}^{2} = arg min {\sum }_{x} {\sum }_{y} {[ ( {\sum }_{i = - \frac{( H - 1 )}{2}}^{\frac{( H - 1 )}{2}} {\sum }_{j = - \frac{( L - 1 )}{2}}^{\frac{( L - 1 )}{2}} {f}_{c} ( i , j ) \times {P}_{Y}^{rec} ( 2 x - i , 2 y - j ) ) + {o}_{c} + {\sum }_{k = 2}^{K - 1} {nl}_{c}^{k} \times {{P}_{Y}^{rec} ( 2 x , 2 y )}^{k} - {P}_{c}^{rec} ( x , y ) ]}^{2} \qquad ( 20 )$$

In one embodiment of the disclosure, the proposed decoder-side derivation method is only applied when the reference picture uses smaller QP value than the current picture.

### Explicit Signaling of the CC-MCP Filter Coefficients

In the above method, the CC-MCP filter coefficients are derived from the neighboring reconstructed samples, which may not be accurate given that the neighboring reconstructed samples may be always highly correlated with the samples in the current block. To resolve the problem, in one embodiment, it is proposed to derive the CC-MCP filter coefficients at encoder and explicitly signal the CC-MCP filter coefficients to decoder.

When such signaling based scheme is used in practical video coding systems, the adaptation of the CC-MCP filter coefficients may be applied at various coding levels, such as, sequence-level, picture/slice-level and/or block-level; and each adaptation level may provide different trade-off between coding efficiency and encoding/decoding complexity. For example, if filter coefficients are adapted at sequence-level, encoder needs to derive the filter coefficients for the whole video sequence, and all the filter coefficients as well as the decision on whether to apply the motion compensated filtering may be carried in sequence-level parameter set, such as video parameter set (VPS) and sequence parameter set (SPS). If filter coefficients are adapted at picture-level, encoder needs to derive the filter coefficients for one picture, and all the filter coefficients as well as the decision on whether to apply the motion compensated filtering may be carried in picture-level parameter set, such as picture parameter set (PPS). If filter coefficients are adapted at slice-level, encoder needs to derive the filter coefficients for each individual slice, and all the filter coefficients as well as the decision on whether to apply the motion compensated filtering may be carried in slice header. Additionally, as the motivation of this disclosure is to recover the high-frequency information in motion compensated chroma signal, the proposed filtering methods may be beneficial only to regions which have rich edge and texture information. Taking this into consideration, region-based filter coefficient adaptation method may be also applied, where the motion compensated filters are signaled for different regions and are only applied to the regions that contain abundant high-frequency details. By this way, the high-pass filters would not be applied to the prediction samples in flat area, which could reduce encoding/decoding complexity. Whether the region is flat or not can be determined by the encoder/decoder based on motion compensated luma samples or reconstructed luma samples.

Handling Uni-Prediction and Bi-Prediction with the CC-MCP

In modern video coding standards, two main prediction types for motion compensated prediction, namely uni-prediction and bi-prediction. For uni-prediction, one uni-directional prediction is applied where each block can be predicted using at most one motion-compensated block from one reference picture; for bi-prediction, bi-directional prediction is applied where one block can be predicted by averaging two motion-compensated blocks from two reference pictures. All the above CC-MCP schemes are discussed based on the assumption that the prediction signal of the current video block to be coded is from one prediction direction, i.e., uni-prediction. For bi-prediction blocks, the proposed motion compensated filtering scheme can be applied in different ways.

In the first method, it is proposed to apply the CC-MCP filter only once to directly enhance the output chroma prediction samples. Specifically, in this method, encoder/decoder firstly generate the motion compensated prediction of the coded video by averaging the two prediction signals from two reference pictures; then the proposed CC-MCP is applied to enhance the quality of the resulting chroma prediction signal.

In the second method, two CC-MCP filtering processes are applied to enhance the motion compensated prediction signals from two reference pictures separately. Specifically, for bi-prediction blocks, the method firstly generates two prediction blocks from two reference picture lists; then the CC-MCP will be applied to enhance the quality of two prediction blocks separately, which are finally averaged to generate the output prediction signal.

### The Adaptive Filtering of Motion Compensated Signal for Luma Component

With the MCP of luma component, the video signal in the current picture is predicted from the reconstructed signal of temporal neighboring reference pictures which may contain unexpected noise and quantization errors. As a result, certain high-frequency information that are present in the original luma signal may be missing or distorted in the reconstructed picture. Therefore, in order to compensate for such distortion, it is proposed to apply one high-pass filtering process to the luma component of motion compensated signal to improve the quality of the motion compensated luma signal. Assume that the proposed filter for motion compensated luma signal is 2D finite impulse response (FIR) filter which consists N×N taps and the filter coefficients are denoted by f_{L}(x, y), where

$$- \frac{N - 1}{2} \leq x , y \leq \frac{N - 1}{2} .$$

The proposed high-pass filtering process for motion compensated luma signal may be calculated by the 2D convolution as

$${Y}^{′} ( x , y ) = Y ( x , y ) * {f}_{L} ( x , y ) + Y ( x , y ) = {\sum }_{m = - \frac{( N - 1 )}{2}}^{\frac{( N - 1 )}{2}} {\sum }_{n = - \frac{( N - 1 )}{2}}^{\frac{( N - 1 )}{2}} Y ( x - m , y - n ) \times {f}_{L} ( m , n ) + Y ( x , y ) \qquad ( 21 )$$

where Y(x, y) and Y′(x, y) are the motion compensated luma signal before and after the filtering process; and * denotes convolution operation.

Similar to (10), additional offset term and non-linear term may be introduced into the proposed adaptive luma MCP filtering process, as illustrated as:

$${Y}^{′} ( x , y ) = Y ( x , y ) * {f}_{L} ( x , y ) + {o}_{L} + {nl}_{L} + Y ( x , y ) = {\sum }_{m = - \frac{( N - 1 )}{2}}^{\frac{( N - 1 )}{2}} {\sum }_{n = - \frac{( N - 1 )}{2}}^{\frac{( N - 1 )}{2}} Y ( x - m , y - n ) \times {f}_{L} ( m , n ) + {o}_{L} + {\sum }_{k = 2}^{K - 1} {nl}_{L}^{k} \times {Y ( x , y )}^{k} + Y ( x , y ) \qquad ( 22 )$$

where o_{L} is the offset and nl_{L} is the non-linear term which is represented as the summation of a series of powers (i.e., k=2, . . . , K−1) of the luma sample Y(x, y).

There may be different schemes to derive the coefficients of the proposed luma MCP filter. In one method, it is proposed to derive the coefficients of the proposed luma MCP filter from the neighboring reconstructed luma samples of the current CU at decoder. Specifically, when such scheme is applied, it calculates the coefficients of the luma MCP filter from the neighboring reconstructed luma samples of the current block. Given one block B and its pre-defined neighboring region P (e.g., the reconstructed luma samples in

$${P}_{Y}^{rec} ) ,$$

we can find the corresponding luma prediction samples

$${P}_{Y}^{pred}$$

using the coded MV of the current block. Then, the LMMSE method can be employed to derive the filter coefficients by minimizing the difference between

$${P}_{Y}^{rec} and {P}_{Y}^{pred} ,$$

i.e.,

$${f}_{L}^{*} = arg min {\sum }_{x} {\sum }_{y} {\vert {P}_{Y}^{out} ( x , y ) - {P}_{Y}^{rec} ( x , y ) \vert}^{2} = arg min {\sum }_{x} {\sum }_{y} {[ ( {\sum }_{i = - \frac{( N - 1 )}{2}}^{\frac{( N - 1 )}{2}} {\sum }_{j = - \frac{( N - 1 )}{2}}^{\frac{( N - 1 )}{2}} {f}_{L} ( i , j ) \times {P}_{Y}^{pred} ( x - i , y - j ) ) + {P}_{Y}^{pred} ( x , y ) - {P}_{Y}^{rec} ( x , y ) ]}^{2} \qquad ( 23 )$$

Additionally, when taking the offset term and non-linear terms in (14) into consideration, the proposed decoder-side filter coefficient derivation of the luma MCP filter can be formulated as

$${f}_{L}^{*} = arg min {\sum }_{x} {\sum }_{y} {\vert {P}_{Y}^{out} ( x , y ) - {P}_{Y}^{rec} ( x , y ) \vert}^{2} = arg min {\sum }_{x} {\sum }_{y} {[ ( {\sum }_{i = - \frac{( N - 1 )}{2}}^{\frac{( N - 1 )}{2}} {\sum }_{j = - \frac{( N - 1 )}{2}}^{\frac{( N - 1 )}{2}} {f}_{L} ( i , j ) \times {P}_{Y}^{pred} ( x - i , y - j ) ) + {o}_{L} + {\sum }_{k = 2}^{K - 1} {nl}_{L}^{k} \times {{P}_{Y}^{pred} ( x , y )}^{k} + {P}_{Y}^{pred} ( x , y ) - {P}_{Y}^{rec} ( x , y ) ]}^{2} \qquad ( 24 )$$

In another scheme, it is proposed to directly derive the luma MCP filter at encoder and signal the corresponding filter coefficients to decoder. Such scheme can reduce the decoding complexity of the proposed luma MCP filtering given that the extra complexity on deriving the MCP filter coefficients can now be waived at decoder. Additionally, when such signaling based scheme is applied, the adaptation of the luma MCP filter can be carried out at different coding levels. Such as VPS, SPS, PPS, picture header/slice header or even coding block level.

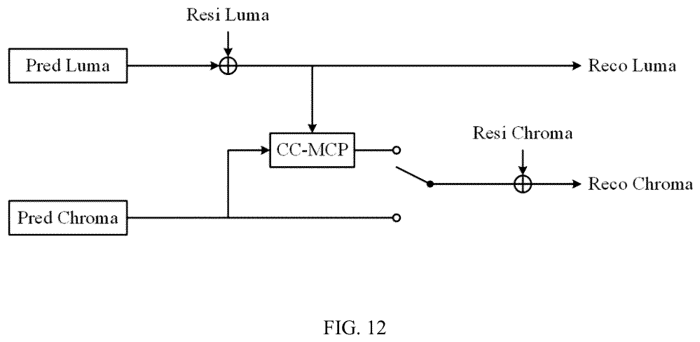

FIG. 13 shows a computing environment (or a computing device) 1310 coupled with a user interface 1350. The computing environment 1310 can be part of a data processing server. In some embodiments, the computing device 1310 can perform any of various methods or processes (such as encoding/decoding methods or processes) as described hereinbefore in accordance with various examples of the present disclosure. The computing environment 1310 may include a processor 1320, a memory 1330, and an I/O interface 1340.

The processor 1320 typically controls overall operations of the computing environment 1310, such as the operations associated with the display, data acquisition, data communications, and image processing. The processor 1320 may include one or more processors to execute instructions to perform all or some of the steps in the above-described methods. Moreover, the processor 1320 may include one or more modules that facilitate the interaction between the processor 1320 and other components. The processor may be a Central Processing Unit (CPU), a microprocessor, a single chip machine, a GPU, or the like.

The memory 1330 is configured to store various types of data to support the operation of the computing environment 1310. Memory 1330 may include predetermine software 1342. Examples of such data include instructions for any applications or methods operated on the computing environment 1310, video datasets, image data, etc. The memory 1330 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 1340 provides an interface between the processor 1320 and peripheral interface modules, such as a keyboard, a click wheel, buttons, and the like. The buttons may include but are not limited to, a home button, a start scan button, and a stop scan button. The I/O interface 1340 can be coupled with an encoder and decoder.

In an embodiment, there is also provided a non-transitory computer-readable storage medium comprising a plurality of programs, for example, in the memory 1330, executable by the processor 1320 in the computing environment 1310, for performing the above-described methods and/or storing a bitstream generated by the encoding method described above or a bitstream to be decoded by the decoding method described above. In one example, the plurality of programs may be executed by the processor 1320 in the computing environment 1310 to receive (for example, from the video encoder 20 in FIG. 1G) a bitstream or data stream including encoded video information (for example, video blocks representing encoded video frames, and/or associated one or more syntax elements, etc.), and may also be executed by the processor 1320 in the computing environment 1310 to perform the decoding method described above according to the received bitstream or data stream. In another example, the plurality of programs may be executed by the processor 1320 in the computing environment 1310 to perform the encoding method described above to encode video information (for example, video blocks representing video frames, and/or associated one or more syntax elements, etc.) into a bitstream or data stream, and may also be executed by the processor 1320 in the computing environment 1310 to transmit the bitstream or data stream (for example, to the video decoder 30 in FIG. 2B). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 1G) using, for example, the encoding method described above for use by a decoder (for example, the video decoder 30 in FIG. 2B) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 1320); and the non-transitory computer-readable storage medium or the memory 1330 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1330, executable by the processor 1320 in the computing environment 1310, for performing the above-described methods. For example, the computer program product may include the non-transitory computer-readable storage medium.

In an embodiment, the computing environment 1310 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

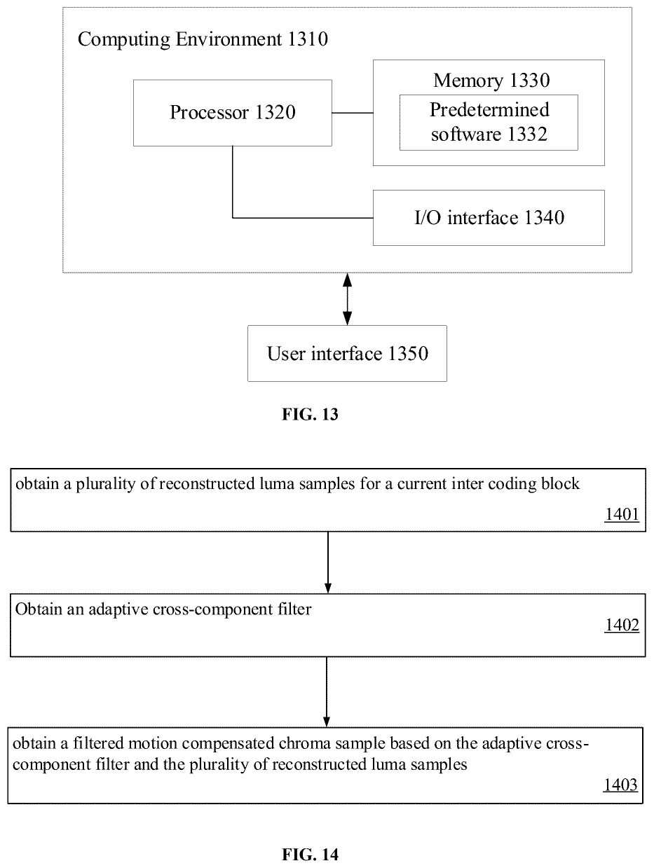

FIG. 14 is a flowchart illustrating a method for video decoding according to an example of the present disclosure. The method may be implemented for decoding an inter coding block.

In Step 1401, the processor 1320, at the side of a decoder, may obtain a plurality of reconstructed luma samples for a current inter coding block. In Step 1402, the processor 1320 may obtain an adaptive cross-component filter. In Step 1403, the processor 1320 may a filtered motion compensated chroma sample based on the adaptive cross-component filter and the plurality of reconstructed luma samples

In some examples, obtaining the adaptive cross-component filter includes: deriving the adaptive cross-component filter based on neighboring reconstructed luma samples and neighboring reconstructed chroma samples.

In some examples, deriving the adaptive cross-component filter based on the neighboring reconstructed luma samples and the neighboring reconstructed chroma samples includes: obtaining an output neighboring chroma sample based on the adaptive cross-component filter and the neighboring reconstructed luma samples; and deriving one or more filter coefficients for the adaptive cross-component filter by minimizing difference between the output neighboring chroma sample and a neighboring reconstructed chroma sample.

In some examples, the one or more filter coefficients includes a linear filter coefficient, an offset term, or a non-linear term.

In some examples, deriving the adaptive cross-component filter based on neighboring reconstructed luma samples and neighboring reconstructed chroma samples includes: in response to determining that a reference picture of the current inter coding block has a smaller quantization parameter (QP) value than a current picture of the current inter coding block, deriving the adaptive cross-component filter based on neighboring reconstructed luma samples and neighboring reconstructed chroma samples.

In some examples, the processor 1320 may further obtain a motion compensated chroma sample; wherein obtaining the filtered motion compensated chroma sample based on the adaptive cross-component filter and the plurality of reconstructed luma samples includes: obtaining the filtered motion compensated chroma sample based on the adaptive cross-component filter, the plurality of reconstructed luma samples, and the motion compensated chroma sample.

In some examples, obtaining the adaptive cross-component filter includes: deriving the adaptive cross-component filter based on neighboring reconstructed luma samples, neighboring reconstructed chroma samples, and motion information of the current inter coding block.

In some examples, deriving the adaptive cross-component filter based on neighboring reconstructed luma samples, the neighboring reconstructed chroma samples, and the motion information of the current inter coding block includes: obtaining a plurality of motion compensated neighboring chroma samples of the neighboring reconstructed chroma samples based on the motion information of the current inter coding block; obtaining an output neighboring chroma sample based on the adaptive cross-component filter, the neighboring reconstructed luma samples, and the plurality of motion compensated neighboring chroma samples; and deriving one or more filter coefficients for the adaptive cross-component filter by minimizing differences between the output neighboring chroma sample and a neighboring reconstructed chroma sample.

In some examples, obtaining the output neighboring chroma sample based on the adaptive cross-component filter, the neighboring reconstructed luma samples, and the plurality of motion compensated neighboring chroma samples includes: obtaining a chroma refinement by applying the adaptive cross-component filter to the neighboring reconstructed luma samples; and obtaining the output neighboring chroma sample based on the chroma refinement and a motion compensated neighboring chroma sample.

In some examples, obtaining the filtered motion compensated chroma sample based on the adaptive cross-component filter, the plurality of reconstructed luma samples, and the motion compensated chroma sample includes: obtaining a chroma refinement by applying the adaptive cross-component filter to the plurality of reconstructed luma samples; and obtaining the filtered motion compensated chroma sample based on the chroma refinement and the motion compensated chroma sample.

In some examples, the one or more filter coefficients includes a linear filter coefficient, an offset term, or a non-linear term.

In some examples, deriving the adaptive cross-component filter based on neighboring reconstructed luma samples, neighboring reconstructed chroma samples, and the motion information of the current inter coding block includes: in response to determining that a reference picture of the current inter coding block has a smaller quantization parameter (QP) value than a current picture of the current inter coding block, deriving the adaptive cross-component filter based on neighboring reconstructed luma samples, neighboring reconstructed chroma samples, and the motion information of the current inter coding block.

In some examples, the processor 1320 may further receive one or more filter coefficients of the adaptive cross-component filter signaled by an encoder, wherein the one or more filter coefficients are signaled at a specific level.

In some examples, obtaining the plurality of reconstructed luma samples for the current inter coding block includes: obtaining a plurality of motion compensated luma samples and a plurality of residual luma samples for the current inter coding block; and obtaining the plurality of reconstructed luma samples based on the plurality of motion compensated luma samples and the plurality of residual luma samples.

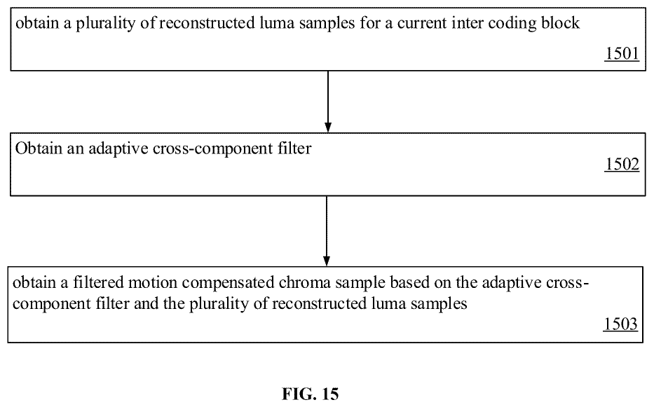

FIG. 15 is a flowchart illustrating a method for video encoding corresponding the method for video decoding as shown in FIG. 14. The method may be implemented for encoding an inter coding block.

In Step 1501, the processor 1320, at the side of an encoder, may obtain a plurality of reconstructed luma samples for a current inter coding block. In Step 1502, the processor 1320 may obtain an adaptive cross-component filter. In Step 1503, the processor 1320 may a filtered motion compensated chroma sample based on the adaptive cross-component filter and the plurality of reconstructed luma samples

In some examples, obtaining the adaptive cross-component filter includes: deriving the adaptive cross-component filter based on neighboring reconstructed luma samples and neighboring reconstructed chroma samples.

In some examples, deriving the adaptive cross-component filter based on the neighboring reconstructed luma samples and the neighboring reconstructed chroma samples includes: obtaining an output neighboring chroma sample based on the adaptive cross-component filter and the neighboring reconstructed luma samples; and deriving one or more filter coefficients for the adaptive cross-component filter by minimizing difference between the output neighboring chroma sample and a neighboring reconstructed chroma sample.

In some examples, the one or more filter coefficients includes a linear filter coefficient, an offset term, or a non-linear term.

In some examples, deriving the adaptive cross-component filter based on neighboring reconstructed luma samples and neighboring reconstructed chroma samples includes: in response to determining that a reference picture of the current inter coding block has a smaller quantization parameter (QP) value than a current picture of the current inter coding block, deriving the adaptive cross-component filter based on neighboring reconstructed luma samples and neighboring reconstructed chroma samples.

In some examples, the processor 1320 may further obtain a motion compensated chroma sample; wherein obtaining the filtered motion compensated chroma sample based on the adaptive cross-component filter and the plurality of reconstructed luma samples includes: obtaining the filtered motion compensated chroma sample based on the adaptive cross-component filter, the plurality of reconstructed luma samples, and the motion compensated chroma sample.

In some examples, obtaining the adaptive cross-component filter includes: deriving the adaptive cross-component filter based on neighboring reconstructed luma samples, neighboring reconstructed chroma samples, and motion information of the current inter coding block.

In some examples, deriving the adaptive cross-component filter based on neighboring reconstructed luma samples, the neighboring reconstructed chroma samples, and the motion information of the current inter coding block includes: obtaining a plurality of motion compensated neighboring chroma samples of the neighboring reconstructed chroma samples based on the motion information of the current inter coding block; obtaining an output neighboring chroma sample based on the adaptive cross-component filter, the neighboring reconstructed luma samples, and the plurality of motion compensated neighboring chroma samples; and deriving one or more filter coefficients for the adaptive cross-component filter by minimizing differences between the output neighboring chroma sample and a neighboring reconstructed chroma sample.

In some examples, obtaining the output neighboring chroma sample based on the adaptive cross-component filter, the neighboring reconstructed luma samples, and the plurality of motion compensated neighboring chroma samples includes: obtaining a chroma refinement by applying the adaptive cross-component filter to the neighboring reconstructed luma samples; and obtaining the output neighboring chroma sample based on the chroma refinement and a motion compensated neighboring chroma sample.

In some examples, obtaining the filtered motion compensated chroma sample based on the adaptive cross-component filter, the plurality of reconstructed luma samples, and the motion compensated chroma sample includes: obtaining a chroma refinement by applying the adaptive cross-component filter to the plurality of reconstructed luma samples; and obtaining the filtered motion compensated chroma sample based on the chroma refinement and the motion compensated chroma sample.

In some examples, the one or more filter coefficients includes a linear filter coefficient, an offset term, or a non-linear term.

In some examples, deriving the adaptive cross-component filter based on neighboring reconstructed luma samples, neighboring reconstructed chroma samples, and the motion information of the current inter coding block includes: in response to determining that a reference picture of the current inter coding block has a smaller quantization parameter (QP) value than a current picture of the current inter coding block, deriving the adaptive cross-component filter based on neighboring reconstructed luma samples, neighboring reconstructed chroma samples, and the motion information of the current inter coding block.

In some examples, the processor 1320 may further signal one or more filter coefficients of the adaptive cross-component filter, wherein the one or more filter coefficients are signaled at a specific level.

In some examples, obtaining the plurality of reconstructed luma samples for the current inter coding block includes: obtaining a plurality of motion compensated luma samples and a plurality of residual luma samples for the current inter coding block; and obtaining the plurality of reconstructed luma samples based on the plurality of motion compensated luma samples and the plurality of residual luma samples.

In some examples, there is provided an apparatus for video coding. The apparatus includes a processor 1320 and a memory 1330 configured to store instructions executable by the processor; where the processor, upon execution of the instructions, is configured to perform any method as illustrated in FIGS. 14-15.

In some other examples, there is provided a non-transitory computer readable storage medium, having instructions stored therein. When the instructions are executed by a processor 1320, the instructions cause the processor to perform any method as illustrated in FIGS. 12-15. In one example, the plurality of programs may be executed by the processor 1320 in the computing environment 1310 to receive (for example, from the video encoder 20 in FIG. 1G) a bitstream or data stream including encoded video information (for example, video blocks representing encoded video frames, and/or associated one or more syntax elements, etc.), and may also be executed by the processor 1320 in the computing environment 1310 to perform the decoding method described above according to the received bitstream or data stream. In another example, the plurality of programs may be executed by the processor 1320 in the computing environment 1310 to perform the encoding method described above to encode video information (for example, video blocks representing video frames, and/or associated one or more syntax elements, etc.) into a bitstream or data stream, and may also be executed by the processor 1320 in the computing environment 1310 to transmit the bitstream or data stream (for example, to the video decoder 30 in FIG. 2B). Alternatively, the non-transitory computer-readable storage medium may have stored therein a bitstream or a data stream including encoded video information (for example, video blocks representing encoded video frames, and/or associated one or more syntax elements etc.) generated by an encoder (for example, the video encoder 20 in FIG. 1G) using, for example, the encoding method described above for use by a decoder (for example, the video decoder 30 in FIG. 2B) in decoding video data. The non-transitory computer-readable storage medium may be, for example, a ROM, a Random Access Memory (RAM), a CD-ROM, a magnetic tape, a floppy disc, an optical data storage device or the like.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for decoding an inter coding block, comprising:
obtaining, by a decoder, a plurality of reconstructed luma samples for a current inter coding block;
obtaining, by the decoder, an adaptive cross-component filter; and
obtaining, by the decoder, a filtered motion compensated chroma sample based on the adaptive cross-component filter and the plurality of reconstructed luma samples.

2. The method of claim 1, wherein obtaining the adaptive cross-component filter comprises:
deriving the adaptive cross-component filter based on neighboring reconstructed luma samples and neighboring reconstructed chroma samples.

3. The method of claim 2, wherein deriving the adaptive cross-component filter based on the neighboring reconstructed luma samples and the neighboring reconstructed chroma samples comprises:
obtaining an output neighboring chroma sample based on the adaptive cross-component filter and the neighboring reconstructed luma samples; and
deriving one or more filter coefficients for the adaptive cross-component filter by minimizing difference between the output neighboring chroma sample and a neighboring reconstructed chroma sample.

4. The method of claim 3, wherein the one or more filter coefficients comprises a linear filter coefficient, an offset term, or a non-linear term.

5. The method of claim 2, wherein deriving the adaptive cross-component filter based on the neighboring reconstructed luma samples and the neighboring reconstructed chroma samples comprises:
in response to determining that a reference picture of the current inter coding block has a smaller quantization parameter (QP) value than a current picture of the current inter coding block, deriving the adaptive cross-component filter based on the neighboring reconstructed luma samples and the neighboring reconstructed chroma samples.

6. The method of claim 1, further comprising:
obtaining, by the decoder, a motion compensated chroma sample;
wherein obtaining the filtered motion compensated chroma sample based on the adaptive cross-component filter and the plurality of reconstructed luma samples comprises:
obtaining the filtered motion compensated chroma sample based on the adaptive cross-component filter, the plurality of reconstructed luma samples, and the motion compensated chroma sample.

7. The method of claim 6, wherein obtaining the adaptive cross-component filter comprises:
deriving the adaptive cross-component filter based on neighboring reconstructed luma samples, neighboring reconstructed chroma samples, and motion information of the current inter coding block.

8. The method of claim 7, wherein deriving the adaptive cross-component filter based on the neighboring reconstructed luma samples, the neighboring reconstructed chroma samples, and the motion information of the current inter coding block comprises:
obtaining a plurality of motion compensated neighboring chroma samples of the neighboring reconstructed chroma samples based on the motion information of the current inter coding block;
obtaining an output neighboring chroma sample based on the adaptive cross-component filter, the neighboring reconstructed luma samples, and the plurality of motion compensated neighboring chroma samples; and
deriving one or more filter coefficients for the adaptive cross-component filter by minimizing differences between the output neighboring chroma sample and a neighboring reconstructed chroma sample.

9. The method of claim 8, wherein obtaining the output neighboring chroma sample based on the adaptive cross-component filter, the neighboring reconstructed luma samples, and the plurality of motion compensated neighboring chroma samples comprises:
obtaining a chroma refinement by applying the adaptive cross-component filter to the neighboring reconstructed luma samples; and
obtaining the output neighboring chroma sample based on the chroma refinement and a motion compensated neighboring chroma sample.

10. The method of claim 8, wherein obtaining the filtered motion compensated chroma sample based on the adaptive cross-component filter, the plurality of reconstructed luma samples, and the motion compensated chroma sample comprises:
obtaining a chroma refinement by applying the adaptive cross-component filter to the plurality of reconstructed luma samples; and
obtaining the filtered motion compensated chroma sample based on the chroma refinement and the motion compensated chroma sample.

11. The method of claim 8, wherein the one or more filter coefficients comprises a linear filter coefficient, an offset term, or a non-linear term.

12. The method of claim 7, wherein deriving the adaptive cross-component filter based on the neighboring reconstructed luma samples, the neighboring reconstructed chroma samples, and the motion information of the current inter coding block comprises:
in response to determining that a reference picture of the current inter coding block has a smaller quantization parameter (QP) value than a current picture of the current inter coding block, deriving the adaptive cross-component filter based on the neighboring reconstructed luma samples, the neighboring reconstructed chroma samples, and the motion information of the current inter coding block.

13. The method of claim 1, further comprising:
receiving, by the decoder, one or more filter coefficients of the adaptive cross-component filter signaled by an encoder, wherein the one or more filter coefficients are signaled at a specific level.

14. The method of claim 1, wherein obtaining the plurality of reconstructed luma samples for the current inter coding block comprises:
obtaining a plurality of motion compensated luma samples and a plurality of residual luma samples for the current inter coding block; and
obtaining the plurality of reconstructed luma samples based on the plurality of motion compensated luma samples and the plurality of residual luma samples.

15. A method for encoding an inter coding block, comprising:
obtaining, by an encoder, a plurality of reconstructed luma samples for a current inter coding block;
obtaining, by the encoder, an adaptive cross-component filter; and
obtaining, by the encoder, a filtered motion compensated chroma sample based on the adaptive cross-component filter and the plurality of reconstructed luma samples.

16. The method of claim 15, wherein obtaining the adaptive cross-component filter comprises:
deriving the adaptive cross-component filter based on neighboring reconstructed luma samples and neighboring reconstructed chroma samples.

17. A method for receiving a bitstream, wherein the bitstream comprises encoded video information to be decoded by the method of claim 1.

18. A method for transmitting a bitstream, wherein the bitstream comprises encoded video information generated by the method of claim 15.

19. An apparatus for video decoding, comprising:
one or more processors; and
a memory coupled to the one or more processors and configured to store instructions executable by the one or more processors,
wherein the one or more processors, upon execution of the instructions, are configured to:
obtain a plurality of reconstructed luma samples for a current inter coding block;
obtain an adaptive cross-component filter; and
obtain a filtered motion compensated chroma sample based on the adaptive cross-component filter and the plurality of reconstructed luma samples.

20. An apparatus for video encoding, comprising:
one or more processors; and
a memory coupled to the one or more processors and configured to store instructions executable by the one or more processors,
wherein the one or more processors, upon execution of the instructions, are configured to perform the method of claim 15.
